(19) United States
(12) Patent Application Publication
(10) Pub. No.: US 2011/0063426 A1
(43) Pub. Date: Mar. 17, 2011

(54) VISION SYSTEM AND METHOD FOR INSPECTING SOLAR CELL STRINGS

(76) Inventors: Brad Dingle, Red Lion, PA (US); Brian Micciche, York, PA (US); Bill Duncan, Elizabethtown, PA (US); Bill Hynak, Mount Wolf, PA (US); David Daniel, Manheim, PA (US); David Beyer, York, PA (US); Ben Gasparin, York, PA (US)

(21) Appl. No.: 12/884,825

(22) Filed: Sep. 17, 2010

Related U.S. Application Data
(60) Provisional application No. 61/243,333, filed on Sep. 17, 2009.

(51) Int. Cl. H04N 7/18

(52) U.S. Cl. 348/61; 348/E07.085

(57) ABSTRACT

A vision system for inspecting an object includes a vision tunnel having a housing with a plurality of panels to define a cavity therebetween. A lighting zone is disposed adjacent the housing, the lighting zone including a light source and a light shield which cooperate to illuminate the object disposed in the lighting zone, while blocking at least a portion of an ambient light. A sensor is disposed in the cavity of the housing to scan the object disposed in the lighting zone.

### CROSS-REFERENCE TO RELATED APPLICATION

This application claims the benefit of U.S. Provisional Patent Application Ser. No. 61/243,333, filed Sep. 17, 2009, hereby incorporated herein by reference in its entirety.

### FIELD OF THE INVENTION

The present invention relates generally to solar cell strings. In particular, the invention is directed to a vision system and a method for inspecting a solar cell string.

### BACKGROUND OF THE INVENTION

To make automatic placement of strings onto glass in a Glass Layup System, the robot placing the strings must be accurate and properly guided to pick and place the string. Vision inspection and alignment of strings in a lay-up system is critical to the system's success. Existing systems place individual strings to a vision table and a camera is moved under servo control along the length of the string, inspecting and gathering position data. The string is then picked from the vision table and placed into a module. The existing systems have not accounted for ambient light levels and variations. The result is a vision system that is difficult to set-up and susceptible to changes in ambient light that may occur at different times of day in a production facility with windows.

Vision inspection and guidance is most reliable when the lighting of the object is carefully controlled and shielded from the effects of ambient light. It is the design of these systems and the management of the light in the environment that makes the system less susceptible to those changes in light throughout the working day.

It would be desirable to develop a vision system and a method for inspecting objects, wherein the system and method minimize a risk of damage and susceptibility to a surrounding environment.

### SUMMARY OF THE INVENTION

Concordant and consistent with the present invention, a vision system and a method for inspecting objects, wherein the system and method minimize a risk of damage and susceptibility to a surrounding environment, has surprisingly been discovered.

The key to success of any vision system is proper optics on the camera and lighting of the work piece. Proper lighting is frequently difficult to achieve since handling systems and cycle times may make it undesirable to place the work piece in a “dark box” for imaging. The present invention provides a small, localized area of lighting control (lighting zone) instead of a large box of darkness.

In addition, the vision system and methods of the present invention provide vision inspection and string location without placing the string onto an inspection table, thereby minimizing cycle time (higher throughput). The vision system and method of the present invention also minimize the risk for cell or string damage because the solar cell string is only picked up once (at a stringer) and placed once (onto the ethylene vinylacetate copolymer (EVA) on the glass panel or onto a matrix assembly fixture).

In one embodiment, a vision tunnel comprises: a housing having a plurality of panels to define a cavity therebetween; a lighting zone disposed adjacent the housing, the lighting zone including a light source and a light shield which cooperate to illuminate the object disposed in the lighting zone, while blocking at least a portion of an ambient light; and a sensor disposed in the cavity of the housing to scan the object disposed in the lighting zone.

In another embodiment, a vision system for inspecting an object comprises: a housing having a plurality of panels to define a cavity therebetween; a lighting zone disposed adjacent the housing, the lighting zone including a light source and a plurality of first light shields, wherein the first light shields are positioned to define a channel therebetween; a pick bar for moving the object through the lighting zone, the pick bar including an engaging device coupled to a main body thereof; and a sensor disposed in the cavity of the housing to scan the object.

The invention also provides methods for inspecting an object.

One method comprises the steps of: providing a lighting zone including a light source and a plurality of first light shields, wherein the first light shields are positioned to define a channel therebetween; providing a pick bar for moving the object through the lighting zone, the pick bar including an engaging device coupled to a main body thereof; scanning the object as the object moves through the lighting zone to gather a data relating to at least one of a position and an orientation of the object; and controlling a movement of the pick bar based upon the data.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of a vision tunnel according to an embodiment of the present invention, shown with a panel in a closed position;

FIG. 2 is a perspective view of the vision tunnel of FIG. 1, shown with a panel in an opened position;

FIG. 3 is an enlarged fragmentary perspective view of the vision tunnel of FIG. 1;

FIG. 4 is a fragmentary front elevational view of a vision system according to an embodiment of the present invention; and

FIG. 5 is an enlarged fragmentary perspective view of the vision system of FIG. 4.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

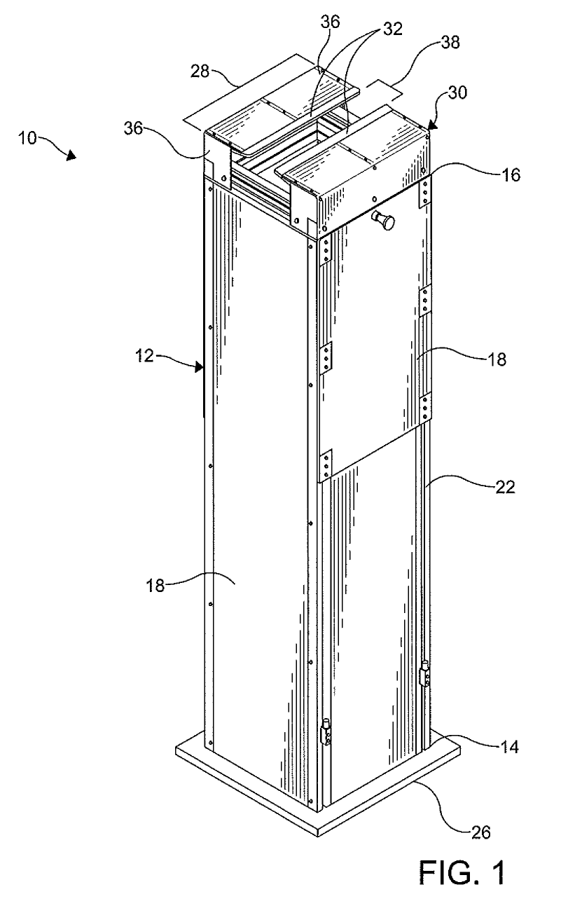

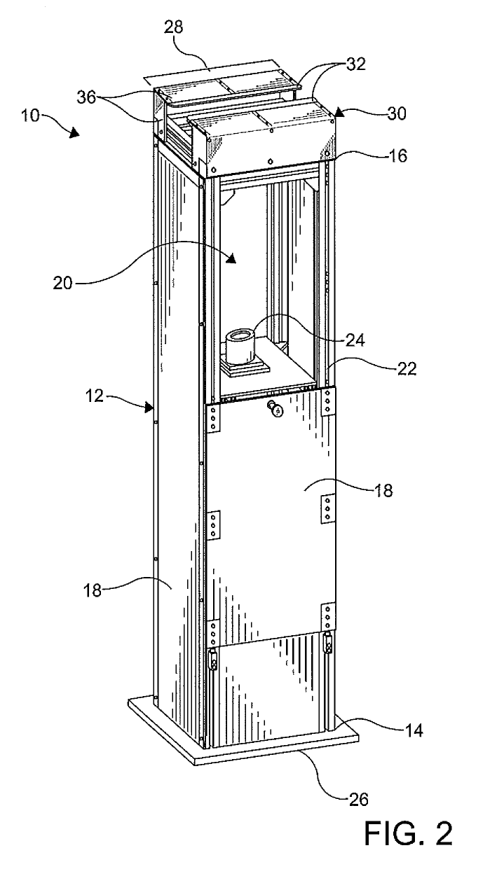

FIGS. 1-3 illustrate a vision tunnel 10 according to an embodiment of the present invention. The vision tunnel 10 includes a housing 12 having a first end 14 and a second end 16. The housing 12 includes a plurality of panels 18 which cooperate to define a cavity 20 therebetween. As shown, at least one of the panels 18 is slidably coupled to a plurality of frame rails 22 to allow movement of the at least one of the panels 18 for accessing the cavity 20. As shown, a light sensor 24 is disposed within the cavity 20. As a non-limiting example, the sensor 24 is a camera such as an Insight® camera manufactured by Cognex Corporation.

In certain embodiments, a base 26 is disposed at the first end 14 of the housing 12 to provide stability to the vision tunnel 10. A lighting zone 28 is disposed at the second end 16 of the housing 12.

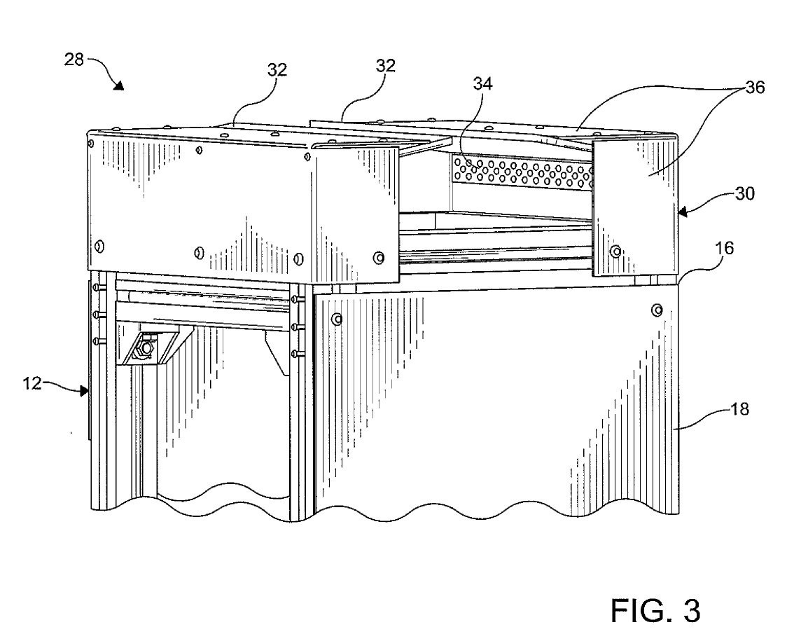

As more clearly shown in FIG. 3, the lighting zone 28 includes a plurality of enclosure elements 30, a plurality of first light shields 32, and a light source 34. As a non-limiting example, the lighting zone 28 may include a plurality of bearing rails (not shown) for aligning and guiding an object through the lighting zone 28. The enclosure elements 30 are mounted to the second end 16 of the housing 12. The enclosure elements 30 include a plurality of flanges 36, which are bent to enclose a portion of the cavity 20.

The first light shields 32 are formed from a “backlighting” material having light reflective qualities. In certain embodiments, the backlighting material is white in color. Each of the first light shields 32 is coupled to at least one of the enclosure elements 30 and the housing 12. As a non-limiting example, each of a pair of the first light shields 32 is coupled on opposite sides of the housing 12 to enclose a portion of the cavity 20 and define an unenclosed channel 38 therebetween.

The light source 34 may be any device for emitting light such as an array of light emitting diodes, for example. The light source 34 is disposed adjacent the housing 12 and at least one of the enclosure elements 30 and adapted to illuminate the lighting zone 28.

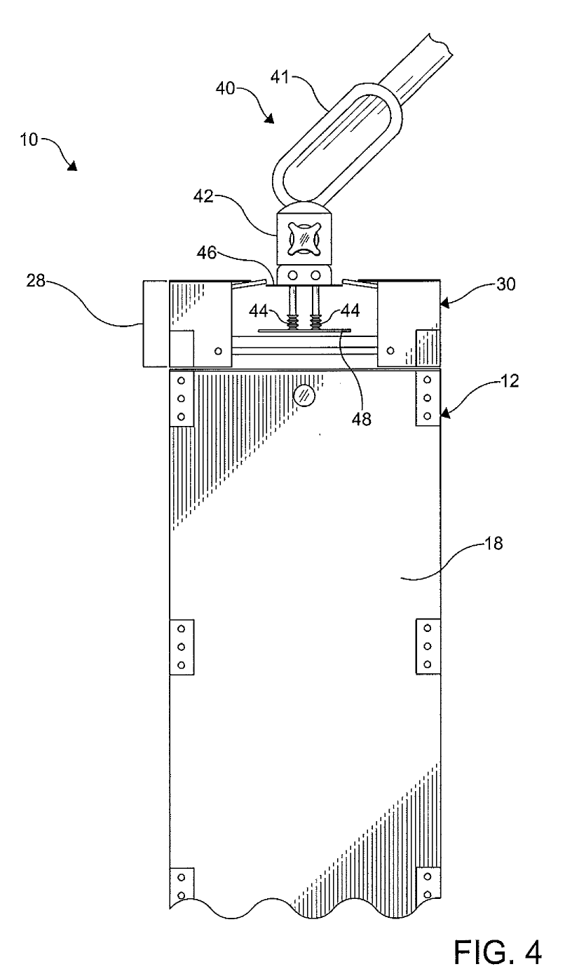

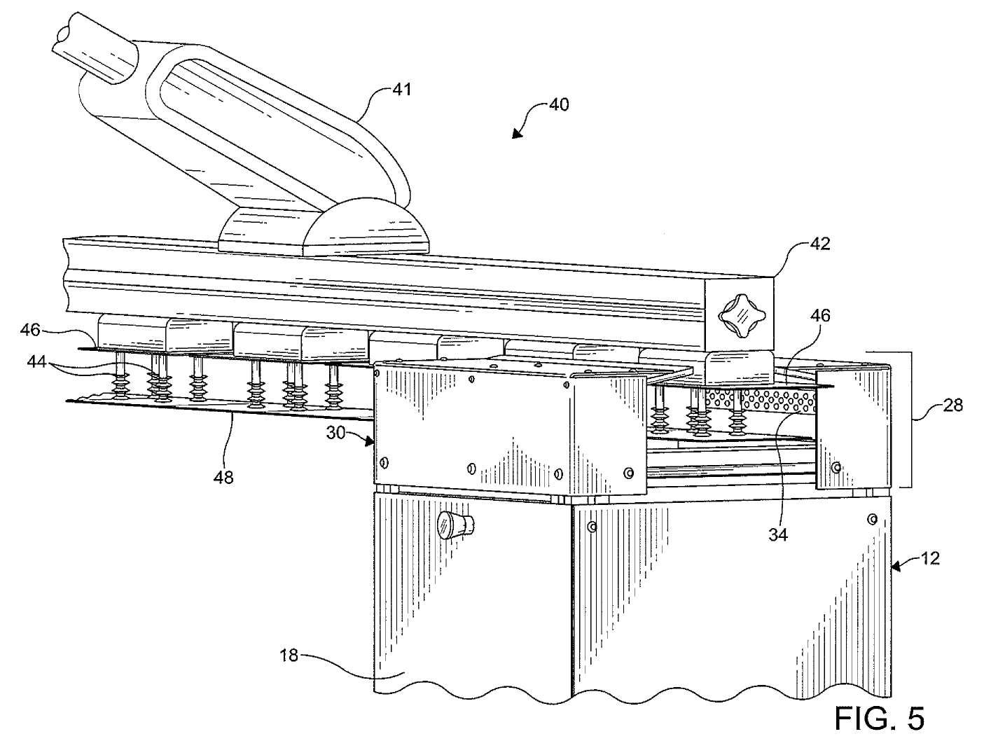

FIGS. 4-5 illustrate a robotic pick bar 40 disposed adjacent the vision tunnel 10, which are collectively referred to as a vision system, according to an embodiment of the present invention. The pick bar 40 includes a main body 42, a plurality of engaging devices 44, and a plurality of second light shields 46. In certain embodiments, the pick bar 40 includes a plurality of bearing rails (not shown) to cooperate with bearings on the vision tunnel 10 for aligning and guiding the pick bar 40 through the light zone 28.

The main body 42 is an elongate member coupled to a robotic controller 41 for moving and rotating the pick bar 40. The engaging devices 44 are coupled to the main body 42 and adapted to engage an object such as a solar cell string 48 to securely move the solar cell string 48. As a non-limiting example, the engaging devices 44 are suction cups. As a further example, the engaging devices 44 are formed from a transparent or translucent material. In certain embodiments, a fixed light source is integrated into each of the engaging devices 44 to maximize illumination of the solar cell string 48.

The second light shields 46 are formed from a “backlighting” material having light reflective qualities. In certain embodiments, the backlighting material is a white colored material. The second light shields 46 are disposed between the engaging devices 44 and the main body 42. As shown, the second light shields 46 are coupled to the main body 42 adjacent each of the engaging devices 44. It is understood that any number of second light shields 46 may be used.

In use, the pick bar 40 guides an object, such as the solar cell string 48, through the lighting zone 28 to be illuminated by the light source 34 and thereafter scanned by the sensor 24. As more clearly shown in FIGS. 4-5, the pick bar 40 is guided through the channel 38. The second light shields 46 mounted on the pick bar 40 cooperate with the first light shields 32 to effectively enclose a portion of the cavity 20 to shelter the cavity 20 from ambient light. The light shields 32, 46 also provide a reflective surface for light emitted by the light source 34 to backlight the solar cell string 48. The light shields 32, 46, the enclosure elements 30, and the panels 18 cooperate to minimize an amount of ambient light entering the lighting zone 28 and cavity 20. As the sensor 24 scans the solar cell string 48, a light outside of the lighting zone 28 does not affect the data gathered by the sensor 24.

In one embodiment, the sensor 24 gathers positional data of the solar cell string 48 in the form of captured images. The positional data gathered from the sensor 24 is processed along with a position of the robotic controller 41 (e.g. encoder) at the time of the image capture for alignment correction. Using this data, the solar cell string 48 is placed into a module properly oriented and aligned. Any strings found to contain damaged cells will be rejected.

Specifically, the sensor 24 captures an image of the individual cells of the solar cell string 48. The captured images are analyzed to determine a transverse center point between a top edge and a bottom edge of each of the individual cells of the solar cell string 48 along the longitudinal axis thereof. As a non-limiting example, the transverse center point of each of the outer most individual cells represent an end point on an “orientation line” of the solar cell string 48 and provide a reference orientation thereof. As a further example, a longitudinal center point along the orientation line can be determined. In certain embodiments, a rotation of the solar cell string 48 is calculated as an angular offset between the orientation line and a calibrated zero-degree position of the robotic controller 41. A relative position is calculated as a rectangular offset between the calculated longitudinal center point and a calibrated center of a wrist joint of the robotic controller 41.

The robotic controller 41 relies upon the data gathered and calculated by the vision system to control the pick bar 40 and to properly place, move, rotate, and orient the solar cell string 48.

The vision system and methods according to the present invention minimize a susceptibility to changes in ambient light throughout the working day. In addition, the vision system and methods of the present invention provide vision inspection and string location without placing the solar cell string 48 onto an inspection table, thereby minimizing cycle time (higher throughput). The vision system and method of the present invention also minimize the risk for damage to the solar cell string 48 or individual cells because the solar cell string 48 is only picked up once (e.g. at the stringer) and placed once (e.g. onto the EVA on the glass panel).

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A vision system for inspecting an object, comprising:
a housing having a plurality of panels forming a cavity therebetween;
a lighting zone disposed adjacent said housing, said lighting zone including a light source and a light shield, said light shield cooperating with said light source to illuminate the object when disposed in said lighting zone, while blocking at least a portion of an ambient light; and
a sensor disposed in said cavity of said housing to scan the object disposed in said lighting zone.

2. The vision system according to claim 1 wherein at least one of said panels is slidably coupled to said housing and is selectively moveable with respect to said housing to provide access to said cavity.

3. The vision system according to claim 1 wherein said sensor is a camera for capturing images of the object.

4. The vision system according to claim 1 wherein said lighting zone includes an enclosure element coupled to said housing, said enclosure element having a plurality of flanges bent to enclose a portion of said cavity.

5. The vision system according to claim 4 wherein said light source is coupled to said enclosure element.

6. The vision system according to claim 4 wherein said light shield is coupled to said enclosure element.

7. The vision system according to claim 1 wherein said light shield is formed from a backlighting material.

8. A vision system for inspecting an object, the vision system comprising:
a housing having a plurality of panels forming a cavity therebetween;
a lighting zone disposed adjacent said housing, said lighting zone including a light source and a plurality of first light shields, wherein said first light shields are positioned to form a channel therebetween;
a pick bar for moving the object through said lighting zone, said pick bar including an engaging device coupled to a main body thereof; and
a sensor disposed in said cavity of said housing to scan the object in said lighting zone.

9. The vision system according to claim 8 wherein at least one of said panels is slidably coupled to said housing and is selectively moveable with respect to said housing to provide access to said cavity.

10. The vision system according to claim 8 wherein said sensor is a camera for capturing images of the object.

11. The vision system according to claim 8 wherein said lighting zone includes an enclosure element coupled to said housing, said enclosure element having a plurality of flanges bent to enclose a portion of said cavity.

12. The vision system according to claim 11 wherein said light source is coupled to said enclosure element.

13. The vision system according to claim 11 wherein said light shield is coupled to said enclosure element.

14. The vision system according to claim 8 wherein said pick bar includes a second light shield disposed between said engaging device and said main body, and wherein said first light shields and said second light shield cooperate to substantially shelter said cavity from ambient light while providing a reflective surface for said light source to backlight the object.

15. A method for inspecting an object, the method comprising the steps of:
providing a lighting zone including a light source and a plurality of first light shields, wherein the first light shields are positioned to form a channel therebetween;
providing a pick bar for moving the object through the lighting zone, the pick bar including an engaging device coupled to a main body thereof for engaging the object;
scanning the object as the object is moved through the lighting zone by the pick bar to gather data relating to at least one of a position and an orientation of the object; and
controlling a movement of the pick bar based upon the data.

16. The method according to claim 15 including scanning the object with a camera for capturing images thereof as the data.

17. The method according to claim 15 wherein the lighting zone includes an enclosure element coupled to the housing, the enclosure element having a plurality of flanges bent to enclose a portion of the cavity.

18. The method according to claim 17 wherein the light source is coupled to the enclosure element.

19. The method according to claim 17 wherein the light shield is coupled to the enclosure element.

20. The method according to claim 15 wherein the pick bar includes a second light shield disposed between the engaging device and the main body, and wherein the first light shields and the second light shield cooperate to substantially shelter the cavity from ambient light while providing a reflective surface for the light source to backlight the object.
